(19) United States
(12) Patent Application Publication
(10) Pub. No.: US 2009/0108608 A1
(43) Pub. Date: Apr. 30, 2009

(54) Coin Bin

(75) Inventor: Robert A. Porcs, Waterford, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 11/877,738

(22) Filed: Oct. 24, 2007

(51) Int. Cl. B60N 3/00

(52) U.S. Cl. 296/37.12; 296/37.1

(57) ABSTRACT

Disclosed is a housing with a coin holder for use in a motor vehicle, the housing having a coin holder with a generally vertically aligned coin slot. The coin slot has an arcuate back wall that adjoins a generally planar first side wall to an oppositely disposed and spaced apart generally planar second side wall. The first side wall, the second side wall and the arcuate back wall define a chamber that is dimensioned such that a coin can slide in a generally vertical direction therein. The coin slot also has a throat adjacent to the chamber, the throat having a first flange that extends from the first side wall and a second flange that extends from the second side wall. The first and second flanges define boundaries to a side opening to the chamber, the opening dimensioned such that the coin is retained in the chamber when the coin is aligned in a generally non-vertical orientation. In some instances, the coin slot is D-shaped when viewed from a top direction and can have a bottom surface that is inclined at an acute angle relative to a horizontal plane. The coin slot can also have a cover panel that prevents coins from exiting or bouncing out of and/or exiting a top opening of the D-shaped coin slot when the motor vehicle travels over rough terrain. In other instances, a storage bin can be adjacent to the coin holder and the storage bin and the coin holder can be part of a functional unit that slides or pivots into and out of an instrument panel of the motor vehicle.

### FIELD OF THE INVENTION

This invention relates generally to a coin holder. More specifically, the invention relates to a coin holder with a D-shaped slot.

### BACKGROUND OF THE INVENTION

Coin bins or coin holders in a vehicle instrument panel or console provide easy access to change when paying tolls, using parking meters and the like. Such coin holders are typically incorporated within a center console or the dashboard of the motor vehicle. In some instances, the coin holder simply includes a tray or storage bin where the coins are placed until removal is required. However such types of coin holders make it difficult for an individual to ascertain which coins are being removed and can cause frustration and/or unsafe driving conditions when change is desired.

In an effort to improve on the storage bin type of coin holders, coin holders with vertically aligned slots have been provided. The slots typically have a side opening that affords for an individual to remove coins from the slots by feeling the coins in the slot using their fingers and then grasping the coins and pulling them in a generally upward direction. However, heretofor manufactured coin slots have been circular or oval shaped, the circular or oval shape resulting in thick sections adjacent to the side opening. The thick sections require excess material when being manufactured and result in unsightly sink marks in these regions due to the contraction of the material during the manufacturing process. In addition, such oval shaped designs may or may not allow an individual to ascertain which coins are being removed when change is needed. As such, an improved coin holder that provides for easy insertion and removal of coins while eliminating the unsightly sink marks typically found in slot type coin holders would be desirable.

### SUMMARY OF THE INVENTION

Disclosed is a housing with a coin holder for use in a motor vehicle, the housing having a coin holder with a generally vertically aligned coin slot. The coin slot has an arcuate back wall that adjoins a generally planar first side wall to an oppositely disposed and spaced apart generally planar second side wall. The first side wall, the second side wall and the arcuate back wall define a chamber that is dimensioned such that a coin can slide in a generally vertical direction therein. The coin slot also has a throat adjacent to the chamber, the throat having a first flange that extends from the first side wall and a second flange that extends from the second side wall. The first and second flanges define boundaries to a side opening to the chamber, the opening dimensioned such that the coin is retained in the chamber when the coin is aligned in a generally non-vertical orientation.

In some instances, the coin slot is D-shaped when viewed from a top direction and can have a bottom surface that is inclined at an acute angle relative to a horizontal plane. The coin slot can also have a cover panel that prevents coins from exiting or bouncing out of and/or exiting a top opening of the D-shaped coin slot when the motor vehicle travels over rough terrain. A storage bin can be adjacent to the coin holder and the storage bin and the coin holder can be part of a functional unit that slides or pivots into and out of an instrument panel of the motor vehicle.

### BRIEF DESCRIPTION OF THE DRAWINGS

FIG. 1 is a perspective view illustrating a location for an embodiment of the present invention;

FIG. 2 is a top view of an embodiment of the present invention;

FIG. 3A is a side cross-sectional view of the embodiment shown in FIG. 2 in a closed position;

FIG. 3B is a side cross-sectional view of the embodiment shown in FIG. 2 in an open position;

FIG. 4 is a perspective view of a cutaway section of an embodiment of the present invention;

FIG. 5 is a side cross-sectional view of an embodiment of the present invention; and

FIG. 6 is a perspective view of a cutaway section of an embodiment of the present invention.

### DETAILED DESCRIPTION OF THE INVENTION

The present invention includes a housing with a coin holder for use in a motor vehicle. As such, the present invention has utility as an article to store coins for a driver and/or occupant of the motor vehicle.

The housing includes a coin holder and optionally a storage bin adjacent thereto. The coin holder can have at least one D-shaped slot, the slot being generally vertically aligned and operable to place coins therein. The D-shaped slot can have a chamber and a throat. The chamber is dimensioned such that coins can be placed within the vertically aligned slot and held therein. The throat provides a side opening to the chamber which can allow an individual's fingers to have access to the coins held in the chamber. In addition, the throat is dimensioned such that the side opening does not allow the coins held within the chamber to slide out of the D-shaped coin slot in a generally horizontal direction. In some instances, the D-shaped coin slot can have a bottom surface that is inclined at an acute angle relative to a horizontal plane. In this manner, coins within the D-shaped coin slot are held at an inclined angle which affords for easy removal from the slot by an individual. The coin holder can also include a cover panel that covers the D-shaped coin slot when the coin holder is in a closed position and thereby prevents coins from bouncing out of and/or exiting a top opening of the coin slot when the motor vehicle is traveling over rough terrain.

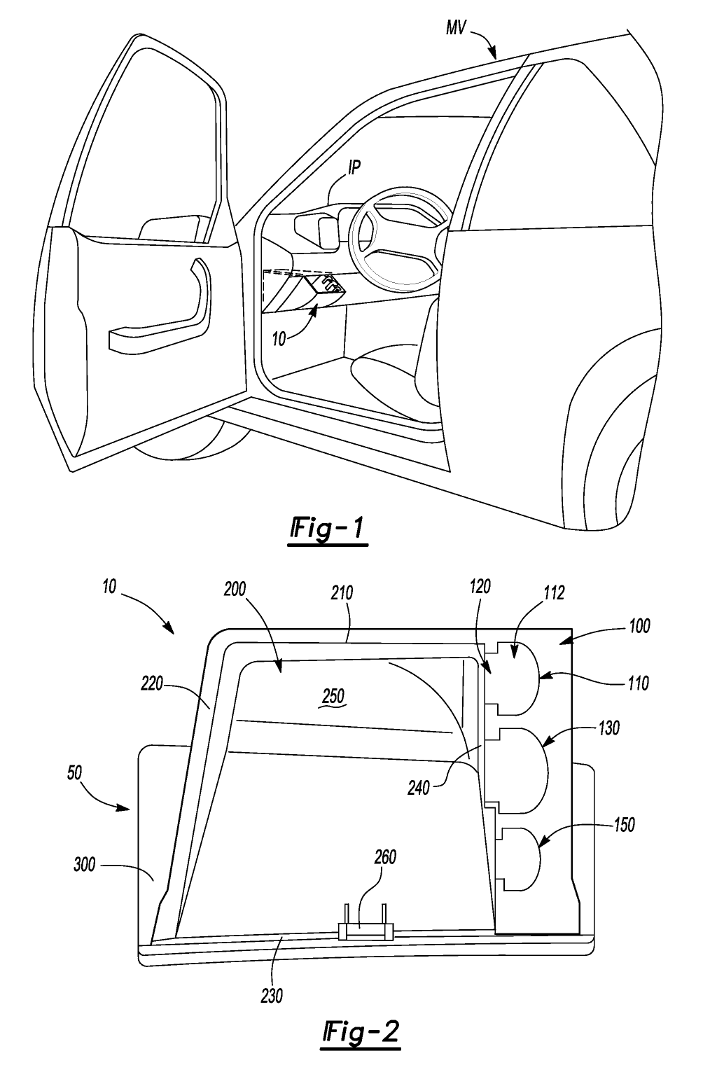

Referring now to FIG. 1, there is shown an embodiment of the coin holder at reference numeral 10. The coin holder 10 can be in the form of a drawer or functional unit that is located at least partially within an instrument panel IP of a motor vehicle MV. It is appreciated that the coin holder 10 can optionally fit within a holder compartment that is part of or attached to the instrument panel IP as illustrated by the dotted lines. In addition, the coin holder 10 does not have to be located in the specific location as illustrated in FIG. 1, but can be located anywhere within the interior of the motor vehicle MV that is convenient for the driver and/or an occupant.

Turning now to FIG. 2, a top view of the coin holder 10 is shown. As illustrated in this figure, the coin holder 10 can have a housing 50 that includes a coin holder 100 and a storage bin 200. The coin holder 10 can also include a cover 300 that is complementary to an opening within the instrument panel IP. The storage bin 200 can include a front wall 210, a first side wall 220, a rear wall 230 and a second side wall 240. In addition, the storage bin 200 can include a floor 250 and an optional latch 260. The front wall 210, the first side wall 220, the rear wall 230, the second side wall 240 and the floor 250 afford for a storage area where items such as a cell phone, receipts, keys and the lice can be stored. Adjacent to the storage bin 200 can be the coin holder 100.

The coin holder 100 includes at least one coin slot 110. In some instances, additional coin slots, for example coin slots 130 and 150, can be present. The coin slot 110 has a chamber 112 and a throat 120. For the purposes of the present invention, a throat is defined as a region with physical dimensions that restrict flow or passage of an item therethrough. It is appreciated that the top view shown in FIG. 2 illustrates that the coin slot has a generally D-shape when viewed from this top perspective.

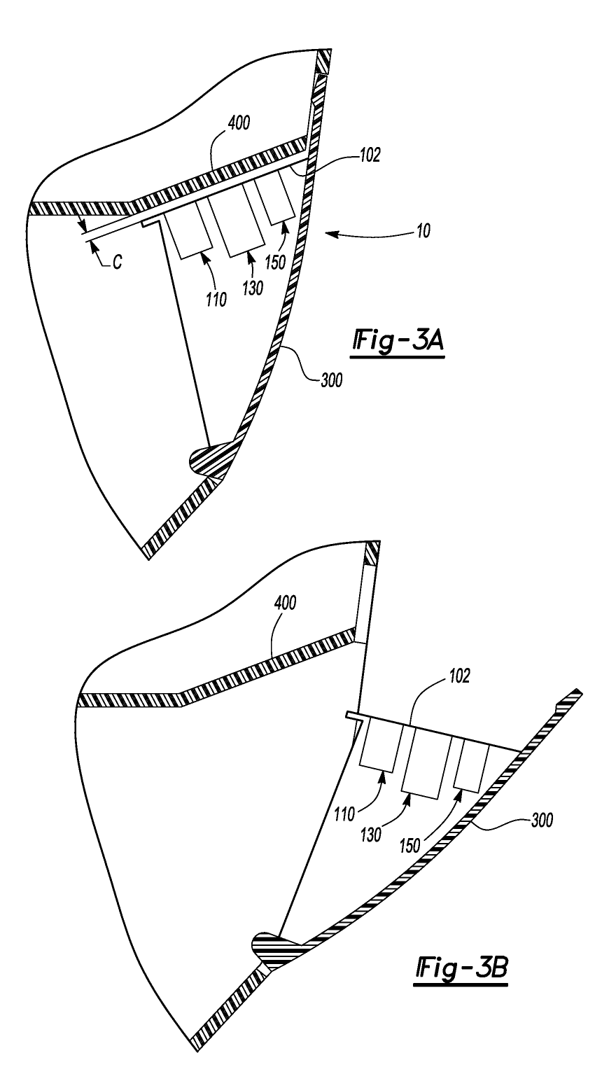

A side cross-sectional view of an embodiment of the coin holder 10 is shown in FIGS. 3A and 3B. FIG. 3A illustrates the coin holder 10 in a closed position with a cover panel 400 proximate to a top surface 102 of the coin holder 100. The clearance ‘c’ between the cover panel 400 and the top surface 102 is such that a coin or coins held within the coin slot 110, 130 and/or 150 are prevented from bouncing out of and/or exiting from a top opening of said coin slot when the motor vehicle travels over rough terrain. In some instances, the clearance ‘c’ is less than 3 millimeters. In other instances, the clearance ‘c’ is less than or equal to 2 millimeters. FIG. 3B illustrates the coin holder in an open position wherein access to a coin or coins within the coin slot 110, 130 and/or 150 is afforded.

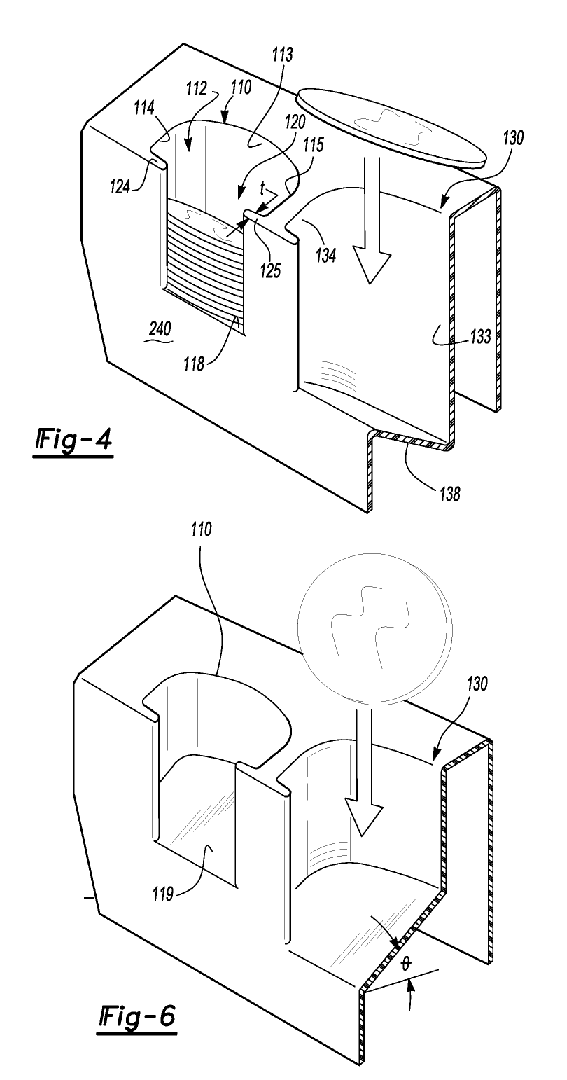

A perspective view of a D-shaped coin slot is illustrated in FIG. 4. In this figure, the coin slot 110 is shown to have coins stacked therein with a cross-sectional view of the coin slot 130 also illustrated. The coin slot 110 has a back arcuate wall 113 that adjoins a first side wall 114 to a second side wall 115. The side wall 114 and/or side wall 115 can be generally planar, or in the alternative be generally non-planar. As shown in this figure, the first side wall 114 is oppositely disposed from and spaced apart from the second side wall 115. The back arcuate wall 113, the first side wall 114 and the second side wall 115 define the chamber 112.

The first side wall 114 can have a flange 124 that extends therefrom in a direction towards the second side wall 115. Likewise, the second side wall 115 can have a flange 125 that extends towards the first side wall 114. The flange 124 and the flange 125 define the throat 120 which provides a side opening to the chamber 112. As shown in FIG. 4, the opening within the throat 112 is dimensioned such that the coins within the slot 110 cannot slide in a generally horizontal direction from the chamber 112 into the storage bin 200.

Also illustrated in FIG. 4 is the D-shaped coin slot 130 which can have a first side wall 134 and a back arcuate wall 133. It is appreciated that the D-shaped coin slot 130 and additional D-shaped coin slots that may be present have the same general shape and function as the D-shaped coin slot 110 described above. It is also appreciated that the general shape and size of the individual coin slots can allow for different sized coins to be stored in each one. For example, the coin slot 150 shown in FIG. 2 can be dimensioned such that only dimes can be placed and stacked therein, whereas the coin slot 110 can be dimensioned such that coins having the size of a nickel and smaller can be stacked therein and the coin slot 130 can be used to hold quarters.

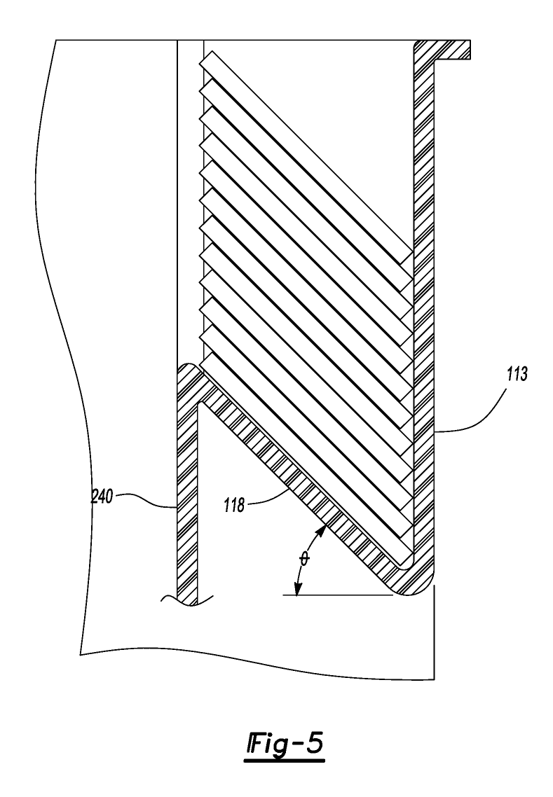

The coin slot 110 has a bottom surface 118 or bottom surface 119 that is inclined at an angle θ relative to a horizontal plane as shown in FIGS. 5 and 6. The angle θ is an acute angle and causes coins within a coin slot to either tilt away from the throat 120 (FIG. 5) or tilt towards the throat 120 (FIG. 6). The angle θ also allows coins having the same diameter to be stacked upon each other and provide a series of steps or ledges in the vertical direction. This series of steps or ledges affords for an individual to ascertain how many coins are present in the coin slot 112 and/or how many are being removed at a given time. In some instances, the bottom surface 118 or bottom surface 119 is inclined relative to the horizontal plane at an angle between 15 and 75 degrees. In other instances, the bottom surface 118 or bottom surface 119 is inclined relative to the horizontal plane at an angle between 30 and 60 degrees.

In operation, the coin holder 10 can be moved to the open position as illustrated in FIG. 3B in which the coin holder 10 pivots out of the instrument panel IP. While in the open position, an individual can place coins within the coin slots 110, 130 and/or 150. In addition, the individual can place other items within the storage bin 200. After the coins and/or items have been placed within the coin holder 10, the holder 10 can be moved to the closed position as illustrated in FIG. 3A wherein the cover 300 fits generally flush with the instrument panel IP and the cover panel 400 prevents the coins from bouncing out of and/or exiting the top opening of the coin slots 110, 130 and/or 150. In this manner, the items and/or the coins to be stored are out of sight to the driver and/or occupants of the vehicle, thereby providing a more aesthetically pleasing interior to the motor vehicle. In addition, when the coin holder 10 is in the closed position, items such as cell phones, coins, etc. are placed out of view from a passerby. When change is needed for paying a toll, paying a parking meter and the like, the driver and/or occupant of the motor vehicle can move the coin holder 10 to the use position and remove coins and/or other items from the holder 10 as desired. Thereafter, the coin holder 10 can be placed back into the stored position.

It is appreciated that the shape of the D-shaped coin slots provide for the flanges that extend from the first and second side walls to have a thickness t as shown in FIG. 4. This thickness t when compared to heretofore coin slots is relatively thin and thereby affords for less material to be used during the manufacturing process. As such, the D-shaped coin slot results in the prevention of unsightly sink marks within the coin holder region. It is also appreciated that the D-shaped coin slots require less material to form the coin holder, thereby reducing the cost of such an item. And it is still further appreciated that the inclined bottom surface provides an improved stacking of the coins such that a specific number of coins can be removed from a given slot more easily than heretofore coin holders.

The foregoing drawings, discussion and description are illustrative of specific embodiments of the present invention, but they are not meant to be limitations upon the practice thereof. Numerous modifications and variations of the invention will be readily apparent to those of skill in the art in view of the teaching presented herein. It is the following claims, including all equivalents, which define the scope of the invention.

I claim:

1. A coin holder for use in a motor vehicle, said coin holder comprising:
a housing having a coin holder with a generally vertically aligned D-shaped coin slot;
said D-shaped coin slot having an arcuate back wall adjoining a generally planar first side wall and an oppositely disposed and spaced apart generally planar second side wall;
said first side wall, said second side wall and said arcuate back wall defining a chamber, said chamber dimensioned such that a coin can slide in a generally vertical direction therein; and
said coin slot also having a throat adjacent to said chamber, said throat having a first flange extending from said first side wall and a second flange extending from said second side wall, said first and second flanges bounding a side opening to said chamber, said opening dimensioned such that the coin is retained in said chamber when the coin is aligned in a generally non-vertical orientation.

2. The coin holder of claim 1, wherein said D-shaped coin slot has a bottom surface, said bottom surface inclined at an acute angle relative to a horizontal plane.

3. The coin holder of claim 2, wherein said bottom surface is inclined relative to said horizontal plane at an angle between 15 degrees and 75 degrees.

4. The coin holder of claim 2, wherein said bottom surface is inclined relative to said horizontal plane at an angle between 30 degrees and 60 degrees.

5. The coin holder of claim 1, wherein said housing is moveably attached to an instrument panel within said motor vehicle.

6. The coin holder of claim 5, wherein said housing is operable to pivot into said instrument panel into a closed position and pivot out of said instrument panel into an open position.

7. The coin holder of claim 6, further comprising a cover panel above said coin slot, said cover panel operable to prevent a coin from exiting a top opening of said coin slot when said housing is in said closed position.

8. The coin holder of claim 1, further comprising a storage bin adjacent to said coin holder.

9. The coin holder of claim 8, wherein said throat of said coin slot is between said chamber and said storage bin.

10. A coin holder for use in a motor vehicle, said coin holder comprising:
a housing having a storage bin and a coin holder;
said coin holder located adjacent to said storage bin and having a generally vertically aligned coin slot; and
a cover panel above said coin slot when said housing is in a stored position, said cover panel operable to prevent a coin from exiting a top opening of said coin slot when said housing is in said stored position.

11. The coin holder of claim 10, wherein said coin slot is D-shaped with a chamber, said chamber having an arcuate back wall adjoining a generally planar first side wall and an oppositely disposed and spaced apart generally planar second side wall.

12. The coin holder of claim 11, wherein said D-shaped coin slot has a bottom surface, said bottom surface inclined at an acute angle relative to a horizontal plane.

13. The coin holder of claim 12, wherein said bottom surface is inclined relative to said horizontal plane at an angle between 15 degrees and 75 degrees.

14. The coin holder of claim 12, wherein said bottom surface is inclined relative to said horizontal plane at an angle between 30 degrees and 60 degrees.

15. The coin holder of claim 11, wherein said housing is moveably attached to a dashboard within said motor vehicle.

16. The coin holder of claim 15, wherein said housing operable to pivot into said instrument panel into a closed position and pivot out of said instrument panel into an open position.
